(19) United States
(12) Patent Application Publication
(10) Pub. No.: US 2025/0251711 A1
(43) Pub. Date: Aug. 7, 2025

(54) NUMERICAL CONTROL DEVICE

(71) Applicant: FANUC CORPORATION, Minamitsuru-gun, Yamanashi (JP)

(72) Inventor: Toshihiro WATANABE, Yamanashi (JP)

(21) Appl. No.: 18/695,114

(22) PCT Filed: Oct. 25, 2021
(86) PCT No.: PCT/JP2021/039357

§ 371 Date: Mar. 7, 2025

(51) Int. Cl. G05B 19/4093; G05B 19/402

(52) U.S. Cl. CPC G05B 19/4093; G05B 19/402; G05B 2219/50052

(57) ABSTRACT

The present invention performs continuous machining while keeping the relative attitude of a tool and a workpiece stable during a program route and thus prevents unevenness occurring in a machining surface of the workpiece. This numerical control device is for a machining tool that performs machining while changing the relative position and relative attitude of a tool and a workpiece in accordance with a program and is provided with: a relative attitude setting unit that sets the relative attitude of the tool and the workpiece during each block or cycle of the program; a dividing unit that provides one or more division points in each block/cycle to divide the block/cycle into two or more sections; and a shaft control unit that moves the tool and workpiece relative to each other such that the tool and the workpiece take the relative attitude set by the relative attitude setting unit in at least one section among the two or more sections.

### TECHNICAL FIELD

The present invention relates to a numerical control device.

### BACKGROUND ART

Such a machining tool is known that uses cooperative movement of a linear axis and a rotation axis to change a relative posture of a tool and a workpiece to machine the workpiece (for example, five-axis machining centers and combined machining machines).

In machining with such a machining tool, such a technique is known that a position of a cutting point and a relative posture are commanded in each block in a program, and a linear axis and a rotation axis are controlled in accordance with such commands and a tool offset that is set beforehand. For example, see Patent Document 1.

### CITATION LIST

### Patent Document

Patent Document 1: Japanese Unexamined Patent Application, Publication No. H5-100723

### DISCLOSURE OF THE INVENTION

### Problems to be Solved by the Invention

Since, in Patent Document 1, a relative posture continuously changes partway through a block, surface roughness on the workpiece becomes uneven, resulting in unevenness on a machining surface.

Although, to prevent unevenness on the machining surface from occurring, it is possible to divide the block into pieces and correct the program to keep the relative posture stable partway through a section, such an issue arises that it is necessary to edit the program, requiring time and effort.

Therefore, it has been demanded to perform continuous machining while keeping a relative posture of a tool and a workpiece stable throughout a program route and prevent unevenness from occurring on a machining surface of the workpiece.

### Means for Solving the Problems

A numerical control device according to an aspect of the present disclosure is a numerical control device for a machining tool that performs machining while changing a relative position and a relative posture of a tool and a workpiece based on a program, which includes: a relative posture setting unit configured to set the relative posture of the tool and the workpiece partway through a block or partway through a cycle in the program; a dividing unit configured to provide one or more division points in the block or the cycle and divide the block or the cycle into two or more sections; and a axis control unit configured to cause the tool or the workpiece to move relative to each other to take the relative posture that the relative posture setting unit has set in at least one section among the two or more sections.

### Effects of the Invention

According to the present aspect, it is possible to perform continuous machining while keeping a relative posture of a tool and a workpiece stable throughout a program route and prevent unevenness from occurring on a machining surface of the workpiece.

### BRIEF DESCRIPTION OF THE DRAWINGS

FIG. 1 is a functional block diagram illustrating a functional configuration example of a numerical control device according to a first embodiment;

FIG. 2 is a diagram illustrating an example of a geometrical shape of a turn-machining multi-edge tool, which is stored in a tool shape storage unit;

FIG. 3 is a diagram illustrating an example of a machining program;

FIG. 4 is a diagram illustrating an example of program routes (machining routes) that the machining program illustrated in FIG. 3 indicates;

FIG. 5 is a diagram illustrating an example of operation of the turn-machining multi-edge tool on a program route N3;

FIG. 6 is a flowchart illustrating control processing in the numerical control device;

FIG. 7 is a functional block diagram illustrating a functional configuration example of a numerical control device according to a second embodiment;

FIG. 8 is a diagram illustrating an example of a geometrical shape of a ball end mill, which is stored in a tool shape storage unit;

FIG. 9 is a diagram illustrating an example of a machining program;

FIG. 10 is a diagram illustrating an example of program routes (machining routes) that the machining program illustrated in FIG. 9 indicates;

FIG. 11 is a diagram illustrating an example of setting processing in a relative posture setting unit;

FIG. 12 is a diagram illustrating an example of division processing in a dividing unit;

FIG. 13 is a diagram illustrating an example of a relationship between a tool tip point of a ball end mill and a projected shadow of the ball end mill;

FIG. 14 is a flowchart illustrating control processing in the numerical control device;

FIG. 15 is a functional block diagram illustrating a functional configuration example of a numerical control device according to a third embodiment;

FIG. 16 is a diagram illustrating an example of a machining program;

FIG. 17 is a diagram illustrating an example of program routes (machining routes) that the machining program illustrated in FIG. 16 indicates;

FIG. 18 is a diagram illustrating an example of operation of a turn-machining multi-edge tool on a program route N3; and

FIG. 19 is a flowchart illustrating control processing in the numerical control device.

### PREFERRED MODE FOR CARRYING OUT THE INVENTION

A first embodiment to a third embodiment will now be described herein in detail with reference to the accompanying drawings.

Note herein that the embodiments are common to each other in configuration where, based on a relative posture of a tool and a workpiece and a geometrical shape of the tool partway through a block or partway through a cycle, one or more division points are provided in each block or each cycle, and the block or the cycle is divided into two or more sections.

In the first embodiment, however, a relative posture of a tool that is a turn-machining multi-edge tool is set with an angle of a B axis to calculate a position of a division point and a feed rate in a block. In the second embodiment, differently from the first embodiment, on the other hand, a relative posture of a tool that is a ball end mill is set with vectors partway through a block and at an end point of the block to calculate a position of a division point and a feed rate in a block. In the third embodiment, differently from the first embodiment and the second embodiment, a position of a division point in a block is set without using a relative posture and a geometrical shape of a tool that is a turn-machining multi-edge tool.

The first embodiment will now first be described herein in detail, and then the second embodiment and the third embodiment will be described by focusing on differences from the first embodiment.

### First Embodiment

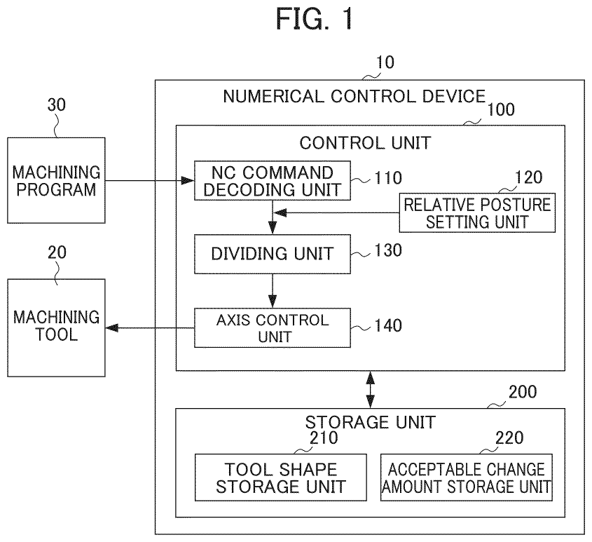

FIG. 1 is a functional block diagram illustrating a functional configuration example of a numerical control device according to the first embodiment. Note herein that a case is exemplified where a turn-machining multi-edge tool is used as a tool. Note that the present invention is not limited to use a turn-machining multi-edge tool, but is applicable to a desired tool.

A numerical control device 10 and a machining tool 20 may be directly coupled to each other via a coupling interface that is not shown. Note that the numerical control device 10 and the machining tool 20 may be coupled to each other via a network that is not shown, such as a local area network (LAN) or the Internet. In this case, the numerical control device 10 and the machining tool 20 each include a communication unit that is not shown, for performing intercommunications through the coupling.

### Machining Tool 20

The machining tool 20 is a lathe used for performing turn-machining, which is known among those skilled in the art, for example, and operates based on an operation command provided from the numerical control device 10 described later.

### Numerical Control Device 10

The numerical control device 10 represents a numerical control device that is known among those skilled in the art, and generates an operation command based on control information, and transmits the generated operation command to the machining tool 20. Thereby, the numerical control device 10 controls operation of the machining tool 20.

As illustrated in FIG. 1, the numerical control device 10 includes a control unit 100 and a storage unit 200. Furthermore, the control unit 100 includes a numerical control (NC) command decoding unit 110, a relative posture setting unit 120, a dividing unit 130, and an axis control unit 140.

### Storage Unit 200

The storage unit 200 is a storage unit such as a solid state drive (SSD) or a hard disk drive (HDD). The storage unit 200 includes a tool shape storage unit 210 and an acceptable change amount storage unit 220.

The tool shape storage unit 210 stores information regarding geometrical shapes of turn-machining multi-edge tools that the machining tool 20 is able to select, for example.

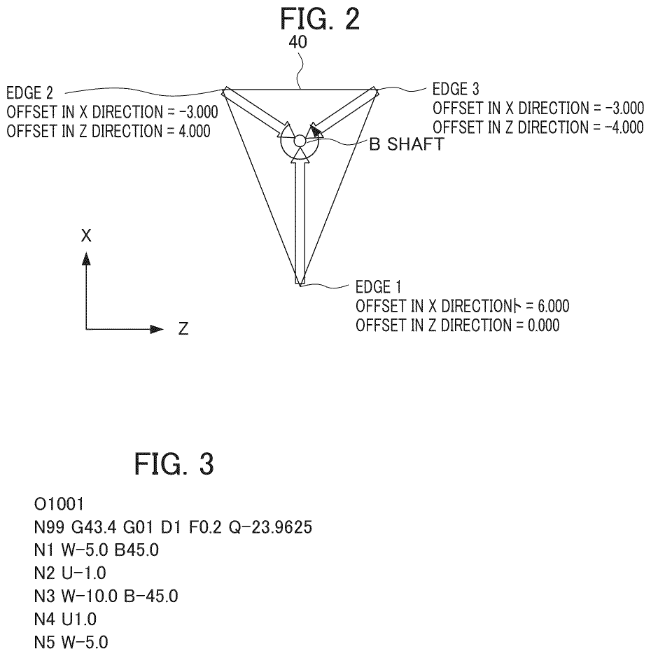

FIG. 2 is a diagram illustrating an example of a geometrical shape of a turn-machining multi-edge tool, which is stored in the tool shape storage unit 210.

As illustrated in FIG. 2, the tool shape storage unit 210 stores offsets of edges on a turn-machining multi-edge tool in X axis direction and Z axis direction, which are indicated by arrows, when the B axis is at an angle of “0 degrees” around a Y axis, per each of the turn-machining multi-edge tools and per each of the edges. In a case of a turn-machining multi-edge tool 40 illustrated in FIG. 2, for example, the tool shape storage unit 210 stores an offset of “6.000” in X axis direction and an offset of “0.000” in Z axis direction of an edge 1, an offset of “−3.000” in X axis direction and an offset of “4.000” in Z axis direction of an edge 2, and an offset of “−3.000” in X axis direction and an offset of “−4.000” in Z axis direction of an edge 3. Note that an angle formed between the X axis and a vector coupling the edge 1 and the edge 2 is tan⁻¹(4/9)(=23.9625 degrees). As will be described later, the angle means a condition for setting an approach angle to 90 degrees.

Note that the tool shape storage unit 210 is not limited to store the offsets of the edges on the turn-machining multi-edge tool 40 in X axis direction and Z axis direction, which are indicated by the arrows, but may store a geometrical shape of the turn-machining multi-edge tool 40, which includes a combination of any one or more of a part of a straight line, a part of a curved line, a part of a flat surface, and a part of a curved surface.

The acceptable change amount storage unit 220 stores an acceptable change amount (i.e., a threshold value) per unit period of time for a relative posture of the turn-machining multi-edge tool 40 and a workpiece 50. Note that the acceptable change amount represents a maximum value of an acceptable rotation speed of the B axis of the turn-machining multi-edge tool 40, and may be determined beforehand by the user in accordance with mechanical characteristics of and a machining condition for the machining tool 20, for example.

### Control Unit 100

The control unit 100 is one that is known among those skilled in the art, and includes a central processing unit (CPU), a read-only memory (ROM), a random access memory (RAM), and a complementary metal-oxide semiconductor (CMOS) memory, which communicate with each other via a bus, for example.

The CPU represents a processor that wholly controls the numerical control device 10. The CPU reads, via the bus, system programs and application programs stored in the ROM, to wholly control the numerical control device 10 in accordance with the system programs and the application programs. Thereby, the control unit 100 achieves functions of the NC command decoding unit 110, the relative posture setting unit 120, the dividing unit 130, and the axis control unit 140, as illustrated in FIG. 1. The RAM stores various types of data including temporal calculation data and display data. The CMOS memory is backed up by a battery that is not shown, and is used as a non-volatile memory that holds a stored state even when a power supply to the numerical control device 10 goes off.

The NC command decoding unit 110 acquires a machining program 30 that an external device such as a device for computer aided designing (CAD)/computer aided manufacturing (CAM) generates, and analyzes the acquired machining program 30, for example.

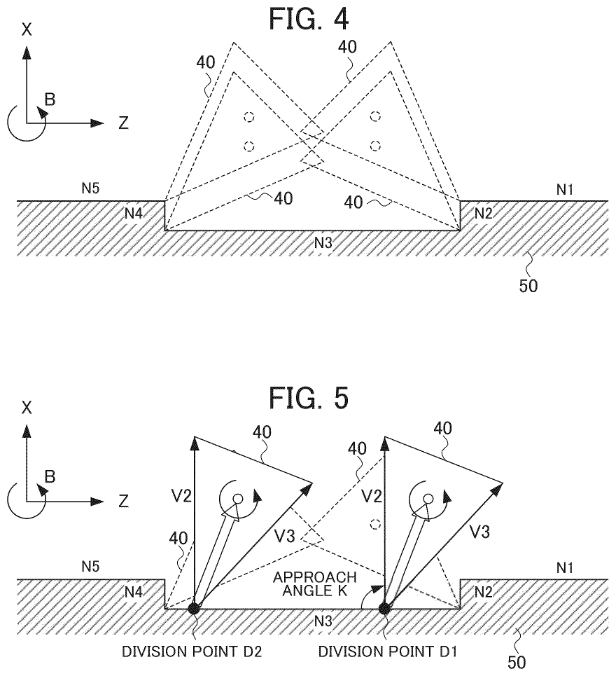

FIG. 3 is a diagram illustrating an example of the machining program 30. FIG. 4 is a diagram illustrating an example of program routes (machining routes) that the machining program 30 illustrated in FIG. 3 indicates. Note that FIG. 4 exemplifies a case where the “edge 1” on the turn-machining multi-edge tool 40 is selected for turning. Furthermore, FIG. 4 illustrates N1 to N5 indicating program routes (machining routes) corresponding to sequence numbers N1 to N5 in the machining program 30, respectively.

The NC command decoding unit 110 analyzes a block with a sequence number N99 in the machining program 30 illustrated in FIG. 3 that, under a tool tip point control mode indicated by “G43.4”, an offset of the edge 1 on the turn-machining multi-edge tool 40, which is indicated by a tool offset number of “D1” and which is stored in the tool shape storage unit 210, is used, and, when the relative posture is changed partway through a block, an angle of the B axis of the turn-machining multi-edge tool 40 is set to “−23.9625 degrees” and turn-machining is performed at a feed rate of “F0.2 (mm/one rotation of a spindle)”. Note herein that the tool tip point control mode refers to a mode under which X, Y, and Z values that the numerical control device 10 has commanded coincide with those of the tool tip point. Furthermore, the tool tip point control mode of G43.4 refers to a tool tip point control mode under which a relative posture is determined by an angle of a rotation axis, as will be described in the first embodiment. Furthermore, in the block with the sequence number N99, various types of information used in a block of N1 and later blocks are indicated. Note that, in this example, the blocks other than the block with the sequence numbers N3 do not satisfy a condition of changing the relative posture partway through each of the blocks, as will be described later.

Furthermore, the NC command decoding unit 110 analyzes the block with the sequence number N1 that, under the tool tip point control mode of “G43.4”, the angle of the B axis of the turn-machining multi-edge tool 40 is set to “45.0 degrees”, and turning is performed at the feed rate of “F0.2 (mm/one rotation of the spindle)” for “−5 mm” in a negative direction of the Z axis. Furthermore, the NC command decoding unit 110 analyzes the block with the sequence number N2 that, under the tool tip point control mode of “G43.4”, the angle of the B axis of the turn-machining multi-edge tool 40 is kept to “45.0 degrees”, and turning is performed at the feed rate of “F0.2 (mm/one rotation of the spindle)” for “−1 mm” in a negative direction of the X axis. Furthermore, the NC command decoding unit 110 analyzes the block with the sequence number N3 that, under the tool tip point control mode of “G43.4”, the angle of the B axis of the turn-machining multi-edge tool 40 is set to “−45.0 degrees”, and turning is performed at the feed rate of “F0.2 (mm/one rotation of the spindle)” for “−10 mm” in the negative direction of the Z axis. Furthermore, the NC command decoding unit 110 analyzes the block with the sequence number N4 that, under the tool tip point control mode of “G43.4”, the angle of the B axis of the turn-machining multi-edge tool 40 is kept to “−45.0 degrees”, and turning is performed at the feed rate of “F0.2 (mm/one rotation of the spindle)” for “1 mm” in a positive direction of the X axis. Furthermore, the NC command decoding unit 110 analyzes the block with the sequence number N5 that, under the tool tip point control mode of “G43.4”, the angle of the B axis of the turn-machining multi-edge tool 40 is kept to “−45.0 degrees”, and turning is performed at the feed rate of “F0.2 (mm/one rotation of the spindle)” for “−5 mm” in the negative direction of the Z axis.

The relative posture setting unit 120 sets a relative posture of the turn-machining multi-edge tool 40 and the workpiece 50 partway through a block or partway through a cycle in the machining program 30 based on a command value in the machining program 30 or a value stored beforehand in the acceptable change amount storage unit 220. Specifically, the relative posture setting unit 120 may use a program command to directly command a relative posture, as illustrated in FIG. 3. Furthermore, an approach angle may be designated in an interactive program format, as will be described later, for example. Furthermore, a relative posture may be stored beforehand in a storage unit as an NC parameter, and the stored relative posture may be used.

Since “B-45.0” is designated in the block with the sequence number N3, as illustrated in FIG. 3, it is necessary to change the angle of the B axis of the turn-machining multi-edge tool 40 from “45 degrees” to “−45 degrees” partway through the block, as illustrated in FIG. 4. Therefore, the relative posture setting unit 120 may use a program command to directly designate a relative posture partway through a block (or partway through a cycle).

The relative posture setting unit 120 may be inputted with an approach angle K of “90 degrees” of the turn-machining multi-edge tool 40 partway through a block, that is, in the block with the sequence number N3, where the angle of the B axis of the turn-machining multi-edge tool 40 changes from “45 degrees” to “−45 degrees”, by the user, via an input device (not shown) such as a keyboard or a touch panel that the numerical control device 10 includes, on an interactive programming screen displayed on a display device (not shown) such as a liquid crystal display that the numerical control device 10 includes, as illustrated in FIG. 5, for example. The relative posture setting unit 120 may use the inputted approach angle K of “90 degrees” to automatically calculate a tool direction (an arrow heading from the edge 1 to the rotation axis, as illustrated in FIG. 5) when the turn-machining multi-edge tool 40 is moving in the negative direction of the Z axis partway through the block with the sequence number N3 to automatically calculate the angle of the B axis of “−23.9625 degrees”. Note that the relative posture setting unit 120 may set beforehand the program command of “Q-23.9625” for the angle of the B axis in the block with the sequence number N99 in the machining program 30, as illustrated in FIG. 3.

Furthermore, the relative posture setting unit 120 may use the approach angle K of “90 degrees” (or the angle of the B axis of “−23.9625 degrees”) stored beforehand in the storage unit 200 to set the program command of “Q-23.9625” for the angle of the B axis of the turn-machining multi-edge tool 40 in the block with the sequence number N99 in the machining program 30.

The dividing unit 130 provides, based on the relative posture of the turn-machining multi-edge tool 40 and the workpiece 50 and the geometrical shape of the turn-machining multi-edge tool 40, one or more division points in each block or each cycle in the machining program 30, and divides the block or the cycle into two or more sections.

Specifically, since the angle of the B axis of the turn-machining multi-edge tool 40 changes from “45 degrees” to “−45 degrees” partway through the block with the sequence number N3, as illustrated in FIG. 5, for example, the dividing unit 130 acquires division points D1 and D2 at which no interference occurs between a contour (the program route) when the turn-machining multi-edge tool 40 and the workpiece 50 take a relative posture that the command “Q-23.9625” designates and the turn-machining multi-edge tool 40.

Based on the offsets of the edges on the turn-machining multi-edge tool 40, which are stored in the tool shape storage unit 210, machining shapes (the program routes) N1 to N5 indicated in the machining program 30 decoded by the NC command decoding unit 110, the angle of “45 degrees” of the B axis of the turn-machining multi-edge tool 40 at a start point (a contour change point) of the block with the sequence number N3, and the relative posture that the command “Q-23.9625” indicates, the dividing unit 130 acquires vectors V2 and V3 heading from an edge tip of the edge 1 on the turn-machining multi-edge tool 40 to the edge 2 and the edge 3 (interference check points), respectively, for example. The dividing unit 130 determines whether or not the acquired vectors V2 and V3 intersect the machining shapes (the program routes) N1 to N5, respectively. The dividing unit 130 acquires a position coordinate of the division point D1, at which no interference occurs between the acquired vectors V2 and V3 and the machining shapes N1 to N5, respectively, and it is possible to change the angle of the B axis of the turn-machining multi-edge tool 40 from “45 degrees” at the start point (the contour change point) to “−23.9625 degrees” (the approach angle K of “90 degrees”).

Specifically, when Ls represents a distance from the start point of the block with the sequence number N3 to the division point D1, and f represents a feed rate in the block with the sequence number N3 (a command value in the machining program 30), the dividing unit 130 calculates a period of time Ts=Ls/f, for which the edge 1 on the turn-machining multi-edge tool 40 is required to move from the start point of the block with the sequence number N3 to the division point D1. The dividing unit 130 calculates a rotation speed Vb1 of the B axis=(−23.9625 degrees−45 degrees)/Ts, at which the edge 1 on the turn-machining multi-edge tool 40 moves from the start point of the block with the sequence number N3 to the division point D1.

Then, the dividing unit 130 acquires a position coordinate of the division point D1, and a feed rate f, at which the tip point of the edge 1 on the turn-machining multi-edge tool 40 moves from the start point of the block (the contour change point) to the division point D1, without allowing the rotation speed Vb1 of the B axis to exceed the acceptable change amount when the angle of the B axis changes from “45 degrees” to “−23.9625 degrees”.

Furthermore, the dividing unit 130 acquires a position coordinate of the division point D2, at which no interference occurs between the acquired vectors V2 and V3 and the machining shapes N1 to N5, respectively, and it is possible to change the angle of the B axis of the turn-machining multi-edge tool 40 from “−23.9625 degrees” to “−45 degrees” at an end point (a contour change point) of the block with the sequence number N3.

That is, when Le represents a distance from the division point D2 to the end point of the block with the sequence number N3, and f represents a feed rate in the block with the sequence number N3 (a command value in the machining program 30), the dividing unit 130 calculates a period of time Te=Le/f, for which the edge 1 on the turn-machining multi-edge tool 40 is required to move from the division point D2 to the end point of the block with the sequence number N3. The dividing unit 130 calculates a rotation speed Vb2 of the B axis=(−45 degrees−(−23.9625 degrees))/Te, at which the edge 1 on the turn-machining multi-edge tool 40 moves from the division point D2 to the end point of the block with the sequence number N3.

The dividing unit 130 acquires a position coordinate of the division point D2, and a feed rate f, at which the tip point of the edge 1 on the turn-machining multi-edge tool 40 moves from the division point D2 to the end point of the block (the contour change point), without allowing the rotation speed Vb2 of the B axis to exceed the acceptable change amount when the angle of the B axis changes from “−23.9625 degrees” to “−45 degrees”.

Note that, if a set value of the acceptable change amount is set smaller, or if a distance Ls from a start point of a block to a division point D1 or a distance Le from a division point D2 to an end point of a block is shorter, a change amount of a relative posture per unit period of time, that is, a rotation speed Vb1 or Vb2 of the B axis may exceed the acceptable change amount. In such a case, and when it is determined that a change amount of a relative posture per unit period of time exceeds the acceptable change amount, the dividing unit 130 may not divide a block (or a cycle).

Furthermore, when an amount of movement in a certain direction (for example, Z axis direction) in a block or a cycle is smaller than a predetermined value (for example, 2 mm) representing a minimum amount of movement, the dividing unit 130 may not divide the block or the cycle. Since an amount of movement in Z axis direction is 0 mm, which is smaller than a minimum amount of movement when it is designated to 2 mm, in the machining routes (the program routes) N2 and N4, the dividing unit 130 may not divide the blocks with the sequence numbers N2 and N4, as illustrated in FIG. 3, for example.

By doing so, the numerical control device 10 is able to prevent negative effects to a machining surface, which may occur if a relative posture intermittently changes in a block according to which an amount of movement is small.

The axis control unit 140 causes the turn-machining multi-edge tool 40 or the workpiece 50 to move relative to each other to take the relative posture that the relative posture setting unit 120 has set in at least one section among the two or more sections.

Specifically, the axis control unit 140 causes the turn-machining multi-edge tool 40 to move relatively to take the relative posture that the relative posture setting unit 120 has set in the section coupling the division points D1 and D2 adjacent to each other among the sections that the dividing unit 130 has divided, for example.

### Control Processing in Numerical Control Device 10

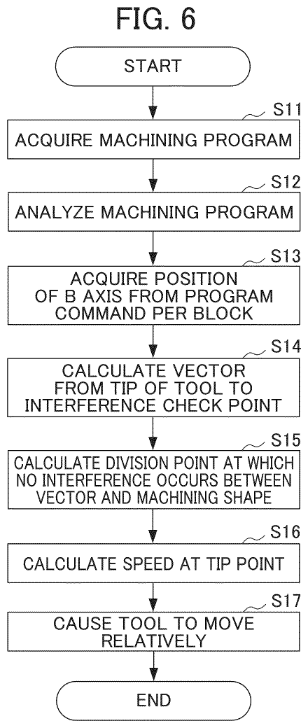

Next, a flow of control processing in the numerical control device 10 will now be described herein with reference to FIG. 6.

FIG. 6 is a flowchart illustrating the control processing in the numerical control device 10. The flow illustrated in here is repeatedly executed each time the machining program 30 is executed.

In Step S11, the NC command decoding unit 110 acquires the machining program 30.

In Step S12, the NC command decoding unit 110 analyzes the machining program 30 acquired in Step S11.

In Step S13, the relative posture setting unit 120 acquires a position of the B axis from the program command of “Q-23.9625” in the block with the sequence number N99 and the program commands of “B45.0” and “B-45.0” in the blocks with the sequence numbers N1 and N3, respectively, in the machining program 30 illustrated in FIG. 3.

In Step S14, the dividing unit 130 calculates vectors V2 and V3 heading from the edge tip of the edge 1 on the turn-machining multi-edge tool 40 to the edge 2 and the edge 3 (the interference check points), respectively, based on the offsets of the edges on the turn-machining multi-edge tool 40, which are stored in the tool shape storage unit 210, the machining shapes (the program routes) indicated in the machining program 30 decoded in Step S12, and the positions of “0-23.9625”, “B45.0”, and “B-45.0” of the B axis, which are acquired in Step S13.

In Step S15, the dividing unit 130 calculates a position of the division point D1, at which no interference occurs between the vectors V2 and V3 calculated in Step S14 and the machining shapes, respectively, and it is possible to change, in the block with the sequence number N3, the angle of the B axis of the turn-machining multi-edge tool 40 from “45 degrees” at the start point (the contour change point) to “−23.9625 degrees”. Furthermore, the dividing unit 130 calculates a position of the division point D2, at which no interference occurs between the vectors V2 and V3 calculated in Step S14 and the machining shapes, respectively, and it is possible to change, in the block with the sequence number N3, the angle of the B axis of the turn-machining multi-edge tool 40 from “−23.9625 degrees” to “−45 degrees” at the end point (the contour change point).

In Step S16, the dividing unit 130 calculates a speed at the tip point of the edge 1 on the turn-machining multi-edge tool 40, without allowing a rotation speed of the B axis when the angle of the B axis changes from “45 degrees” to “−23.9625 degrees” when the edge 1 on the turn-machining multi-edge tool 40 moves from the start point (the contour change point) to the division point D1 to exceed the acceptable change amount. Furthermore, the dividing unit 130 calculates a speed at the tip point of the edge 1 on the turn-machining multi-edge tool 40, without allowing a rotation speed of the B axis when the angle of the B axis changes from “−23.9625 degrees” to “−45 degrees” when the edge 1 on the turn-machining multi-edge tool 40 moves from the division point D2 to the end point of the block (the contour change point) to exceed the acceptable change amount.

In Step S17, the axis control unit 140 causes the turn-machining multi-edge tool 40 to move relatively to take the relative posture that the relative posture setting unit 120 has set in the section coupling the division points D1 and D2 adjacent to each other among the sections divided in Step S15.

As described above, the numerical control device 10 according to the first embodiment is able to add the program command of “Q-23.9625” in the machining program 30, and perform continuous machining while keeping the relative posture of the tool and the workpiece stable partway through the block, that is, partway through the section coupling the division points D1 and D2 adjacent to each other, making it possible to prevent unevenness from occurring on the machining surface of the workpiece 50.

Furthermore, the numerical control device 10 does not require the user to divide a block in the machining program 30 for keeping a relative posture stable partway through the block, making it possible to reduce time and effort for the user. The first embodiment has been described above.

### Second Embodiment

Next, the second embodiment will now be described herein. In the first embodiment, the relative posture of the turn-machining multi-edge tool 40 has been set with the angle of the B axis under the tool tip point control mode of “G43.4” to calculate a position of a division point and a feed rate in a block. In the second embodiment, differently from the first embodiment, on the other hand, a relative posture of a ball end mill 45 is set with vectors partway through a block and at an end point of the block under a tool tip point control mode of “G43.5” to calculate a position of a division point and a feed rate in the block.

Thereby, a numerical control device 10A according to the second embodiment makes it possible to perform continuous machining while keeping a relative posture of a tool and a workpiece stable throughout a program route and prevent unevenness from occurring on a machining surface of the workpiece.

The second embodiment will now be described herein.

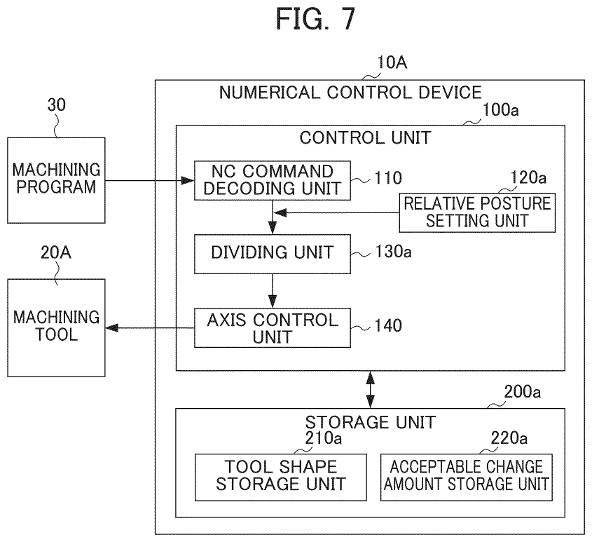

FIG. 7 is a functional block diagram illustrating a functional configuration example of the numerical control device 10A according to the second embodiment. Note that, for those elements having functions identical or similar to those of the elements of the numerical control device 10 illustrated in FIG. 1, identical reference symbols are attached, and detailed descriptions are omitted.

The numerical control device 10A and a machining tool 20A may be directly coupled to each other via a coupling interface that is not shown. Note that the numerical control device 10A and the machining tool 20A may be coupled to each other via a network that is not shown, such as a LAN or the Internet. In this case, the numerical control device 10A and the machining tool 20A each include a communication unit that is not shown, for performing intercommunications through the coupling.

### Machining Tool 20A

The machining tool 20A is a 5-axis machining machine that is known among those skilled in the art, for example, and operates based on an operation command provided from the numerical control device 10A described later.

### Numerical Control Device 10A

The numerical control device 10A includes a control unit 100a and a storage unit 200a, as illustrated in FIG. 7. Furthermore, the control unit 100a includes an NC command decoding unit 110, a relative posture setting unit 120a, a dividing unit 130a, and an axis control unit 140.

### Storage Unit 200a

The storage unit 200a is a storage unit such as an SSD or an HDD. The storage unit 200a includes a tool shape storage unit 210a and an acceptable change amount storage unit 220a.

The tool shape storage unit 210a stores information regarding geometrical shapes of ball end mills that are able to be attached to the machining tool 20A, for example.

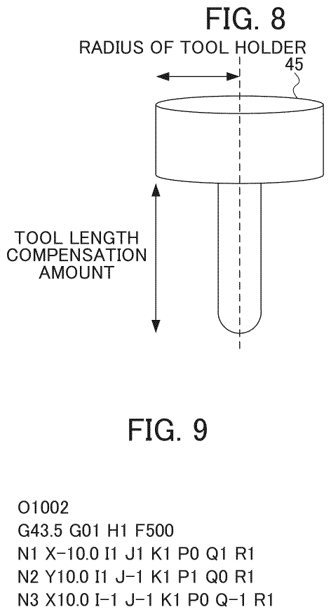

FIG. 8 is a diagram illustrating an example of a geometrical shape of a ball end mill, which is stored in the tool shape storage unit 210a.

As illustrated in FIG. 8, the tool shape storage unit 210a stores a tool length compensation amount for the ball end mill 45 and a radius of a tool holder.

Note that the tool shape storage unit 210a is not limited to store the tool length compensation amount for the ball end mill 45 and the radius of the tool holder, but may store a geometrical shape of the ball end mill 45, which includes a combination of any one or more of a part of a straight line, a part of a curved line, a part of a flat surface, and a part of a curved surface.

The acceptable change amount storage unit 220a stores an acceptable change amount (i.e., a threshold value) per unit period of time for a relative posture of the ball end mill 45 and a workpiece 50. Note that the acceptable change amount represents a maximum value of a rotation speed of each of an A axis and a C axis of the ball end mill 45, and may be determined beforehand by a user in accordance with mechanical characteristics of and a machining condition for the machining tool 20A, for example.

### Control Unit 100a

The control unit 100a is one that is known among those skilled in the art, and includes a CPU, a ROM, a RAM, and a CMOS memory, which communicate with each other via a bus, for example.

The CPU represents a processor that wholly controls the numerical control device 10A. The CPU reads, via the bus, system programs and application programs stored in the ROM, to wholly control the numerical control device 10A in accordance with the system programs and the application programs. Thereby, the control unit 100a achieves functions of the NC command decoding unit 110, the relative posture setting unit 120a, the dividing unit 130a, and the axis control unit 140, as illustrated in FIG. 7.

The NC command decoding unit 110 and the axis control unit 140 respectively have functions equivalent to those of the NC command decoding unit 110 and the axis control unit 140 according to the first embodiment.

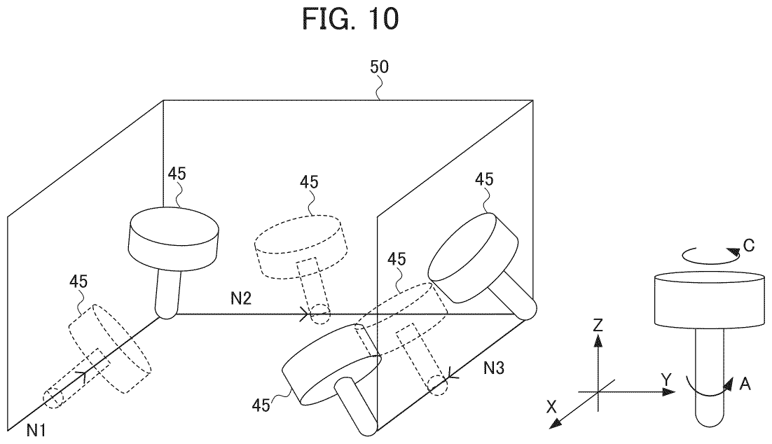

FIG. 9 is a diagram illustrating an example of a machining program 30. FIG. 10 is a diagram illustrating an example of program routes (machining routes) that the machining program 30 illustrated in FIG. 9 indicates. Note that FIG. 10 exemplifies a case where the ball end mill 45 performs cut-machining to form a pocket shape based on the machining program 30 illustrated in FIG. 9. Furthermore, FIG. 10 illustrates N1 to N3 indicating program routes (machining routes) corresponding to sequence numbers N1 to N3 in the machining program 30, respectively.

The NC command decoding unit 110 analyzes a second block in the machining program 30 with a program name of “01002” illustrated in FIG. 9 that, under a control mode indicated by “G43.5”, a tool length compensation amount indicated by a tool offset number of “H1” for the ball end mill 45 indicated in FIG. 8, which is stored in the tool shape storage unit 210a, is used, and cut-machining is performed with the ball end mill 45 at a feed rate of “F500 (mm/min)”. Note herein that the tool tip point control mode of G43.5 refers to, as will be described in the second embodiment, a tool tip point control mode under which it is determined a relative posture at an end point of a block with an address of I (X axis direction), J (Y axis direction), and K (Z axis direction) and a relative posture partway through the block with an address of P (X axis direction), Q (Y axis direction), and R (Z axis direction).

Furthermore, the NC command decoding unit 110 analyzes a third block with the sequence number N1 that, under the tool tip point control mode of “G43.5”, the A axis and/or the C axis of the ball end mill 45 are/is rotated, to cause a relative posture of a vector heading from a tip of the ball end mill 45 to a base of the tool holder and the workpiece 50 to face in a direction of “(P, Q, R)=(0, 1, 1)” partway through the block and in a direction of “(I, J, K)=(1, 1, 1)” at an end point of the block, and cutting is performed at the feed rate of “F500 (mm/min)” for “−10 mm” in the negative direction of the X axis. Furthermore, the NC command decoding unit 110 analyzes a fourth block with the sequence number N2 that, under the tool tip point control mode of “G43.5”, the A axis and/or the C axis of the ball end mill 45 are/is rotated, to cause the relative posture of the vector heading from the tip of the ball end mill 45 to the base of the tool holder and the workpiece 50 to face in a direction of “(P, Q, R)=(1, 0, 1)” partway through the block and in a direction of “(I, J, K)=(1, −1, 1)” at an end point of the block, and cutting is performed at the feed rate of “F500 (mm/min)” for “10 mm” in a positive direction of the Y axis. Furthermore, the NC command decoding unit 110 analyzes a fifth block with the sequence number N3 that, under the tool tip point control mode of “G43.5”, the A axis and/or the C axis of the ball end mill 45 are/is rotated, to cause the relative posture of the vector heading from the tip of the ball end mill 45 to the base of the tool holder and the workpiece 50 to face in a direction of “(P, Q, R)=(0, −1, 1)” partway through the block and in a direction of “(I, J, K)=(−1, −1, 1)” at an end point of the block, and cutting is performed at the feed rate of “F500 (mm/min)” for “10 mm” in the positive direction of the X axis.

The relative posture setting unit 120a sets a relative posture of the ball end mill 45 and the workpiece 50 partway through a block and at an end point of the block in each of the blocks with the sequence numbers N1 to N3 in the machining program 30 based on a command value in the machining program 30 or a value stored beforehand in the acceptable change amount storage unit 220a.

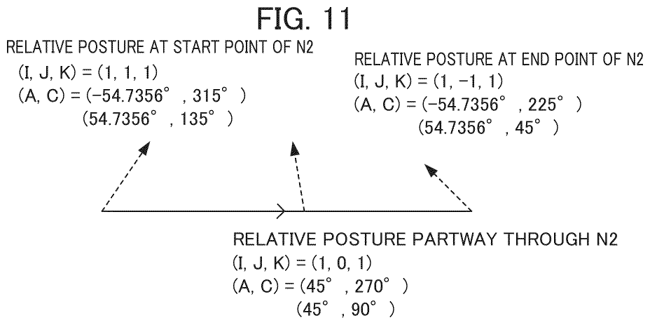

FIG. 11 is a diagram illustrating an example of setting processing in the relative posture setting unit 120a. Note that, although FIG. 11 exemplifies the setting processing in the relative posture setting unit 120a in a case of the block with the sequence number N2, cases of the blocks with the sequence numbers N1 and N3 are similar to the case of the block with the sequence number N2, respectively.

Specifically, the relative posture setting unit 120a may be inputted with relative postures partway through the block with the sequence number N2 and at the end point of the block as “(P, Q, R)=(1, 0, 1)” and “(I, J, K)=(1, −1, 1)”, respectively, by the user, via an input device (not shown) that the numerical control device 10A includes, on an interactive programming screen displayed on a display device (not shown) that the numerical control device 10A includes, as illustrated in FIGS. 9 and 11, for example. The relative posture setting unit 120a uses the input of “(P, Q, R)=(1, 0, 1)” to calculate coordinate values of the A axis and the C axis of the ball end mill 45 partway through the block with the sequence number N2 as (A, C)=(−45°, 270°) and (45°, 90°). Furthermore, the relative posture setting unit 120a uses the input of “(I, J, K)=(1, −1, 1)” to calculate coordinate values of the A axis and the C axis of the ball end mill 45 at the end point of the block with the sequence number N2 as (A, C)=(−54.7356°, 225°) and (54.7356°, 45°). Note that the relative posture setting unit 120a regards a relative posture at a start point of the block with the sequence number N2 as the relative posture of “(I, J, K)=(1, 1, 1)” at the end point of the block with the sequence number N1, and calculates coordinate values of the A axis and the C axis of the ball end mill 45 as (A, C)=(−54.7356°, 315°) and (54.7356°, 135°).

Then, the relative posture setting unit 120a selects and sets a combination of (A, C)=(−54.7356°, 315°), (−45°, 270°), (−54.7356°, 225°) with which an amount of movement of the C axis of the ball end mill 45 is reduced when the ball end mill 45 moves from the start point of the block with the sequence number N2 to the end point of the block.

Note that the relative posture setting unit 120a may use, per block, a relative posture partway through the block and a relative posture at an end point of the block, which are stored beforehand in the storage unit 200a, to set (P, Q, R) and (I, J, K) in the blocks with the sequence numbers N1 to N3 in the machining program 30.

The dividing unit 130a acquires a division point at which a relative posture of the ball end mill 45 at the start point of the block with the sequence number N2 changes to a relative posture of the ball end mill 45 partway through the block and a division point at which the relative posture of the ball end mill 45 partway through the block changes to a relative posture of the ball end mill 45 at the end point of the block, respectively.

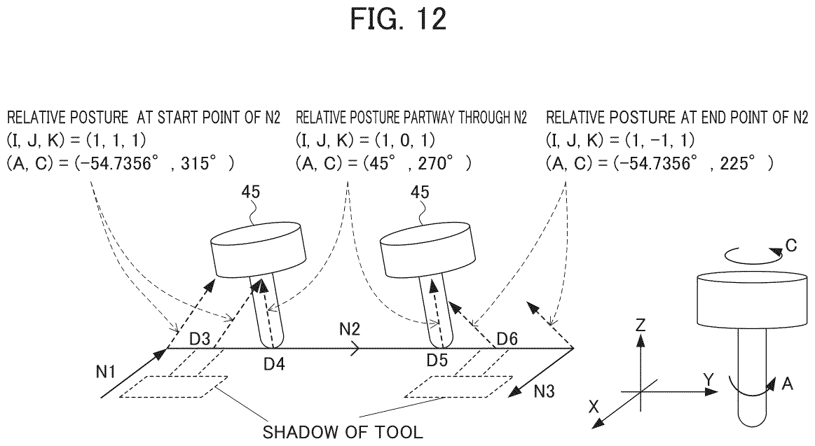

FIG. 12 is a diagram illustrating an example of division processing in the dividing unit 130a.

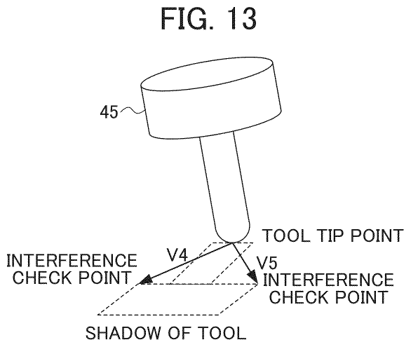

As illustrated in FIG. 12, the dividing unit 130a causes, when a relative posture of the ball end mill 45 partway through the block with the sequence number N2 is ((I, J, K)=(1, 0, 1) or (A, C)=(−45°, 270°)), a shadow of the ball end mill 45 to be projected onto a flat surface stretching in accordance with the program route with the sequence number N1 and the program route with the sequence number N2. The dividing unit 130a calculates vectors V4 and V5 heading from the tool tip point of the ball end mill 45 to lower ends on the projected shadow (illustrated by a dotted line) of the tool holder of the ball end mill 45, respectively, as illustrated in FIG. 13. The dividing unit 130a uses the calculated vectors V4 and V5 and sets, as a division point D3, a position at which the projected shadow of the ball end mill 45 does not intersect the program route with the sequence number N1.

Note that the ball end mill 45 moves from the start point of the block with the sequence number N2 to the division point D3 while keeping the relative posture of (I, J, K)=(1, 1, 1) (or (A, C)=(−54.7356°, 315°)) stable, and, after passing the division point D3, takes a relative posture partway through the block, which is designated as (P, Q, R)=(1, 0, 1) (or (A, C)=(−45°, 270°)).

Therefore, when Ls represents a distance from the division point D3 to a division point D4, and f represents a feed rate in the block with the sequence number N2 (a command value in the machining program 30), the dividing unit 130a calculates a period of time Ts=Ls/f, for which the ball end mill 45 is required to move from the division point D3 to the division point D4. The dividing unit 130a calculates a rotation speed Va1 of the A axis=(−45 degrees−(−54.7356 degrees))/Ts, and calculates a rotation speed Vc1 of the C axis=(270 degrees−315 degrees)/Ts, when the ball end mill 45 moves from the division point D3 to the division point D4. The dividing unit 130a acquires a position coordinate of the division point D4, and a feed rate f, at which the ball end mill 45 moves from the division point D3 to the division point D4, without allowing the rotation speeds Va1 and Vc1 of the A axis and the C axis to exceed the acceptable change amount stored in the acceptable change amount storage unit 220a, respectively.

Furthermore, the dividing unit 130a causes, when a relative posture of the ball end mill 45 partway through the block with the sequence number N2 is ((I, J, K)=(1, 0, 1) or (A, C)=(−45°, 270°)), a shadow of the ball end mill 45 to be projected onto a flat surface stretching in accordance with the program route with the sequence number N2 and the program route with the sequence number N3, respectively, to calculate vectors V4 and V5, similar to FIG. 13. The dividing unit 130a uses the calculated vectors V4 and V5 and sets, as a division point D6, a position at which the projected shadow of the ball end mill 45 does not intersect the program route with the sequence number N3.

Note that, before the ball end mill 45 passes the division point D6, the relative posture partway through the block, which is designated as (P, Q, R)=(1, 0, 1) (or (A, C)=(−45°, 270°)), changes to a relative posture at the end point of the block with the sequence number N2, which is designated as (I, J, K)=(1, −1, 1) (or (A, C)=(−54.7356°, 225°)). Therefore, the dividing unit 130a acquires a position of a division point D5, without allowing the rotation speeds of the A axis and the C axis to exceed the acceptable change amount stored in the acceptable change amount storage unit 220a, respectively.

Specifically, when Le represents a distance from the division point D5 to the division point D6, and f represents a feed rate in the block with the sequence number N2 (a command value in the machining program 30), the dividing unit 130a calculates a period of time Te=Le/f, for which the ball end mill 45 moves from the division point D5 to the division point D6. The dividing unit 130a calculates a rotation speed Va2 of the A axis=(−54.7356 degrees−(−45 degrees))/Te, and calculates a rotation speed Vc2 of the C axis=(225 degrees−270 degrees)/Te, when the ball end mill 45 moves from the division point D5 to the division point D6. The dividing unit 130a acquires a position coordinate of the division point D5, and a feed rate f, at which the ball end mill 45 moves from the division point D5 to the division point D6, without allowing the rotation speeds Va2 and Vc2 of the A axis and the C axis to exceed the acceptable change amount stored in the acceptable change amount storage unit 220a, respectively.

Note that, if a set value of the acceptable change amount is set smaller, or if a distance Ls from the division point D3 to the division point D4 or a distance Le from the division point D5 to the division point D6 is shorter, a change amount of a relative posture per unit period of time, that is, the rotation speed Va2 or Vc2 of the A axis or the C axis may exceed the acceptable change amount. In such a case, and when it is determined that a change amount of a relative posture per unit period of time exceeds the acceptable change amount, the dividing unit 130a may not divide a block (or a cycle).

Furthermore, when an amount of movement in a certain direction (for example, each of X axis direction, Y axis direction, and Z axis direction) in a block or a cycle is smaller than a predetermined value (for example, 2 mm) representing a minimum amount of movement, the dividing unit 130a may not divide the block or the cycle.

By doing so, the numerical control device 10 is able to prevent negative effects to a machining surface, which may occur if a relative posture intermittently changes in a block according to which an amount of movement is small.

### Control Processing in Numerical Control Device 10A

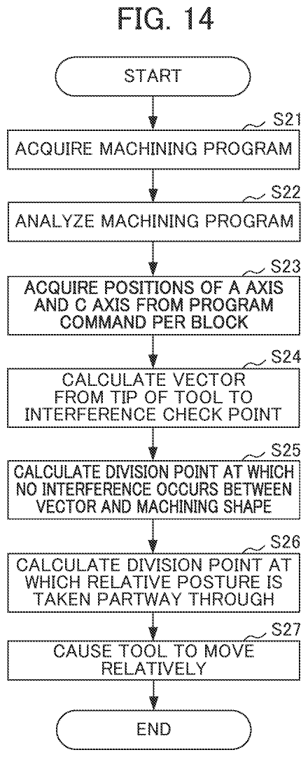

Next, a flow of control processing in the numerical control device 10A will now be described herein with reference to FIG. 14.

FIG. 14 is a flowchart illustrating the control processing in the numerical control device 10A. The flow illustrated in here is repeatedly executed each time the machining program 30 is executed.

Note that Steps S21 and S22 in the processing are identical or similar to Steps S11 and S12 in the processing illustrated in FIG. 6, respectively, and their descriptions are omitted.

In Step S23, the relative posture setting unit 120a calculates, per block in the machining program illustrated in FIG. 9, positions of the A axis and the C axis of the ball end mill 45 based on a relative posture at a start point of the block, a relative posture partway through the block, and a relative posture at an end point of the block. The relative posture setting unit 120a selects and acquires (sets) a combination of the positions of the A axis and the C axis per block, with which an amount of movement of the C axis of the ball end mill 45 is reduced.

In Step S24, the dividing unit 130a causes a shadow of the ball end mill 45 taking the relative posture at the start point of the block (or the end point of the block) to be projected onto a flat surface stretching in accordance with program routes (machining routes) adjacent to each other, and calculates vectors V4 and V5 heading from the tool tip point of the ball end mill 45 to lower ends on the projected shadow of the tool holder of the ball end mill 45, respectively.

In Step S25, the dividing unit 130a calculates a division point D3 (or a division point D6) at which the shadow of the ball end mill 45, which is projected by using the vectors V4 and V5 calculated in Step S24, does not intersect an adjacent one of the program routes (the machining routes).

In Step S26, the dividing unit 130a calculates a division point D4 at which the relative posture of the ball end mill 45 at the position of the division point D3 changes to a relative posture partway through the block, without allowing the rotation speeds of the A axis and the C axis to exceed the acceptable change amount stored in the acceptable change amount storage unit 220a, respectively. Furthermore, the dividing unit 130a calculates a division point D5 at which the relative posture partway through the block changes to a relative posture of the ball end mill 45 at a position of a division point D6, without allowing the rotation speeds of the A axis and the C axis to exceed the acceptable change amount stored in the acceptable change amount storage unit 220a, respectively.

In Step S27, the axis control unit 140 causes the ball end mill 45 to move relatively to take the relative postures that the relative posture setting unit 120a has set in the section between the start point of the block and the division point D3, the section coupling the division points D4 and D5 adjacent to each other, and the section between the division point D6 and the end point of the block among the sections divided in Steps S25 and S26.

As described above, the numerical control device 10A according to the second embodiment uses the program commands of “P0 Q1 R1”, “P1 Q0 R1”, and “P0 Q-1 R1” in the machining program 30, sets a relative posture partway through a block, and performs continuous machining in the section between the start point of the block and the division point D3, the section coupling the division points D4 and D5 adjacent to each other, and the section between the division point D6 and the end point of the block while keeping the relative posture of the tool and the workpiece stable, making it possible to prevent unevenness from occurring on the machining surface of the workpiece 50.

Furthermore, the numerical control device 10 does not require the user to divide a block in the machining program 30 for keeping a relative posture stable partway through the block, making it possible to reduce time and effort for the user.

The second embodiment has been described above.

Next, the third embodiment will now be described herein. In the first embodiment, a relative posture of the turn-machining multi-edge tool 40 has been set with an angle of the B axis under the tool tip point control mode of “G43.4” to calculate a position of a division point and a feed rate in a block. In the second embodiment, on the other hand, a relative posture of the ball end mill 45 has been set under the tool tip point control mode of “G43.5” based on vectors partway through a block and at an end point of the block to calculate a position of a division point and a feed rate in a block. In the third embodiment, differently from the first embodiment and the second embodiment, on the other hand, a relative posture of a turn-machining multi-edge tool 40 is set under a tool tip point control mode of “G43.4” with an angle of the B axis, and a position of a division point in a block is set without using a relative posture and a geometrical shape of the turn-machining multi-edge tool 40.

Thereby, a numerical control device 10B according to the third embodiment makes it possible to perform continuous machining while keeping a relative posture of a tool and a workpiece stable throughout a program route and prevent unevenness from occurring on a machining surface of the workpiece.

The third embodiment will now be described herein.

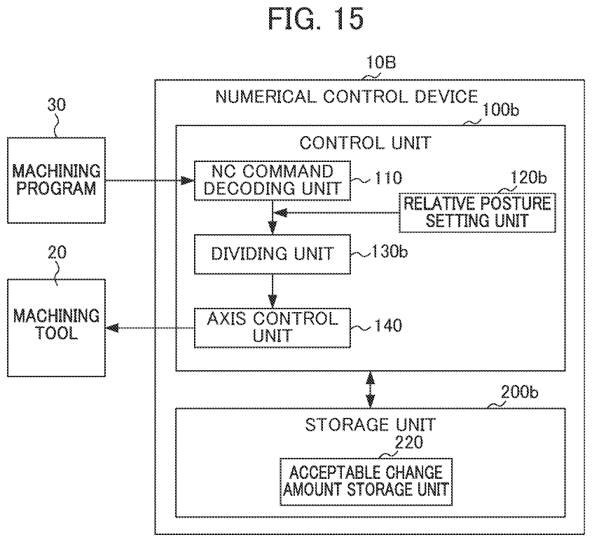

FIG. 15 is a functional block diagram illustrating a functional configuration example of the numerical control device 10B according to the third embodiment. Note that, for those elements having functions identical or similar to those of the elements of the numerical control device 10 illustrated in FIG. 1, identical reference symbols are attached, and detailed descriptions are omitted.

The numerical control device 10B and a machining tool 20 may be directly coupled to each other via a coupling interface that is not shown. Note that the numerical control device 10B and the machining tool 20 may be coupled to each other via a network that is not shown, such as a LAN or the Internet. In this case, the numerical control device 10B and the machining tool 20 each include a communication unit that is not shown, for performing intercommunications through the coupling.

### Numerical Control Device 10B

The numerical control device 10B includes a control unit 100b and a storage unit 200b, as illustrated in FIG. 15. Furthermore, the control unit 100b includes an NC command decoding unit 110, a relative posture setting unit 120, a dividing unit 130b, and a axis control unit 140.

### Storage Unit 200b

The storage unit 200b is a storage unit such as an SSD or an HDD. The storage unit 200b includes an acceptable change amount storage unit 220.

The acceptable change amount storage unit 220 stores data similar to that stored in the acceptable change amount storage unit 220 according to the first embodiment.

### Control Unit 100b

The control unit 100b is one that is known among those skilled in the art, and includes a CPU, a ROM, a RAM, and a CMOS memory, which communicate with each other via a bus, for example.

The CPU represents a processor that wholly controls the numerical control device 10B. The CPU reads, via the bus, system programs and application programs stored in the ROM, to wholly control the numerical control device 10B in accordance with the system programs and the application programs. Thereby, as illustrated in FIG. 15, the control unit 100b achieves functions of the NC command decoding unit 110, the relative posture setting unit 120, the dividing unit 130b, and the axis control unit 140.

The NC command decoding unit 110, the relative posture setting unit 120, and the axis control unit 140 respectively have functions equivalent to those of the NC command decoding unit 110, the relative posture setting unit 120, and the axis control unit 140 according to the first embodiment.

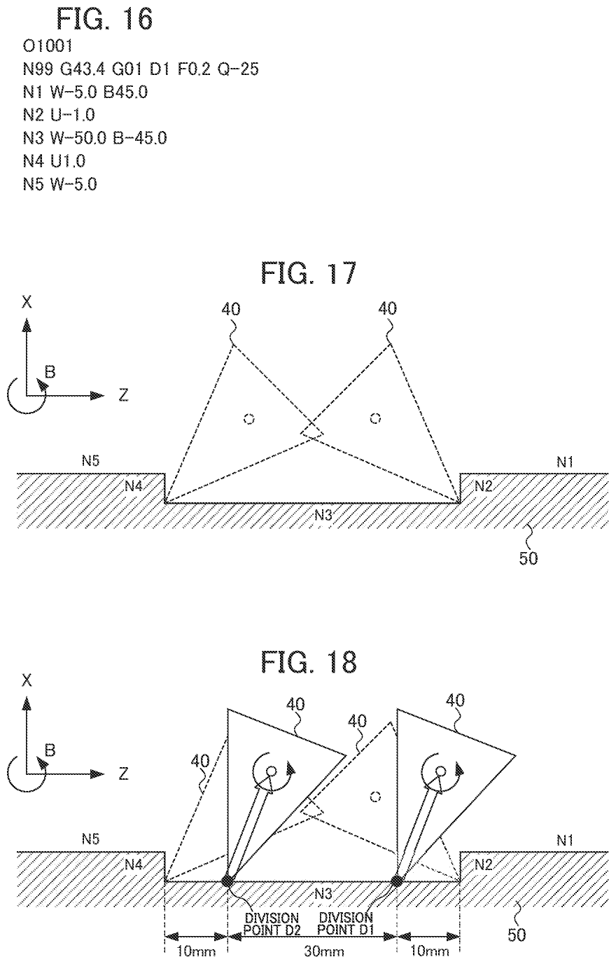

FIG. 16 is a diagram illustrating an example of a machining program 30. FIG. 17 is a diagram illustrating an example of program routes (machining routes) that the machining program 30 illustrated in FIG. 16 indicates. Note that FIG. 17 exemplifies a case where the turn-machining multi-edge tool 40 performs turn-machining based on the machining program 30 illustrated in FIG. 16, similar to the case of the first embodiment.

Furthermore, the machining program 30 illustrated in FIG. 16 is identical or similar to the machining program 30 illustrated in FIG. 3, excluding that a change to “W-50.0” is made in a block with a sequence number N3, that is, a length of a program route (a machining route) corresponding to the sequence number N3 is changed from “10 mm” to “50 mm”, and detailed descriptions are omitted.

Furthermore, an angle of “−25 degrees” of the B axis of the turn-machining multi-edge tool 40 when a relative posture is to be changed partway through a block in a block with a sequence number N99 represents a value that the user (or a machine builder, for example) has experimentally determined based on an idea that “with this value, the machining surface does not become rough”, for example.

That is, the relative posture setting unit 120 may be inputted with the angle of “−25 degrees” of the B axis of the turn-machining multi-edge tool 40 partway through a block, that is, in the block with the sequence number N3, where the angle of the B axis of the turn-machining multi-edge tool 40 changes from “45 degrees” to “−45 degrees”, by the user, via an input device (not shown) that the numerical control device 10 includes, on an interactive programming screen displayed on a display device (not shown) that the numerical control device 10 includes, similar to the case of the first embodiment, for example. Then, a program command of “Q-25” for the angle of the B axis may be set in the block with the sequence number N99 in the machining program 30.

The dividing unit 130b provides, without using the relative posture of the turn-machining multi-edge tool 40 and a workpiece 50 and a geometrical shape of the turn-machining multi-edge tool 40, one or more division points in each block or each cycle in the machining program 30, and divides the block or the cycle into two or more sections.

Since the user (or the machine builder, for example) knows, about distances “from a start point of a block to a division point D1” and “from a division point D2 to an end point of the block” (for example, 10 mm), values experimentally determined based on an idea that “with the values, no interference occurs between the turn-machining multi-edge tool 40 and the workpiece 50”, as illustrated in FIG. 18, for example, the distances “from the start point of the block to the division point D1” and “from the division point D2 to the end point of the block” (for example, 10 mm) may be stored beforehand in the storage unit 200b. The dividing unit 130b may not use the relative posture and the geometrical shape of the turn-machining multi-edge tool 40, but may acquire a division point D1 at a position at a distance of “10 mm” from a start point of a block that is the block with the sequence number N3 and a division point D2 at a position at a distance of “40 mm” from the start point of the block, respectively, based on the distances “from the start point of the block to the division point D1” and “from the division point D2 to the end point of the block”, which are stored in the storage unit 200b.

### Control Processing in Numerical Control Device 10B

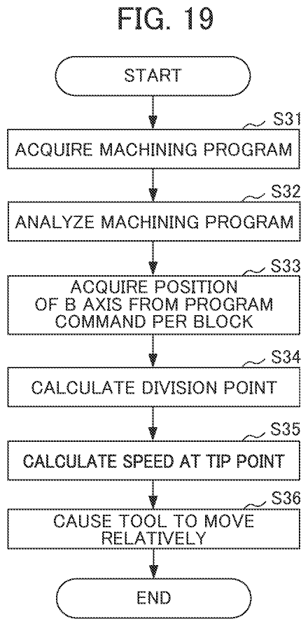

Next, a flow of control processing in the numerical control device 10B will now be described herein with reference to FIG. 19.

FIG. 19 is a flowchart illustrating the control processing in the numerical control device 10. The flow illustrated in here is repeatedly executed each time the machining program 30 is executed.

Note that Steps S31 to S33, S35, and S36 in the processing are identical or similar to Steps S11 to S13, S16, and S17 in the processing illustrated in FIG. 6, respectively, and their descriptions are omitted.

In Step S34, the dividing unit 130b calculates positions of division points D1 and D2 based on the distances “from the start point of the block to the division point D1” and “from the division point D2 to the end point of the block”, which are stored in the storage unit 200b.

The numerical control device 10B according to the third embodiment sets the program command of “Q-25” in the machining program 30 based on values experimentally determined by the user (or the machine builder, for example), acquires positions of division points D1 and D2, and performs continuous machining throughout a program route, that is, in a section coupling the division points D1 and D2 adjacent to each other while keeping the relative posture of the tool and the workpiece, making it possible to prevent unevenness from occurring on the machining surface of the workpiece 50, as described above.

Furthermore, the numerical control device 10B does not require the user to divide a block in the machining program 30 for keeping a relative posture stable partway through the block, making it possible to reduce time and effort for the user.

The third embodiment has been described above.

Although the first embodiment, the second embodiment, and the third embodiment have been described, the numerical control devices 10, 10A, and 10B are not limited to those according to the embodiments described above, but include modifications and improvements that fall within the scope of the present invention, as long as it is possible to achieve the object of the present invention.

### Modification Example 1

Although, in the first embodiment, the second embodiment, and the third embodiment, the numerical control devices 10, 10A, and 10B are different devices from the machining tools 20 and 20A, respectively, the present invention is not limited to those cases. The numerical control devices 10, 10A, and 10B may be included in the machining tools 20 and 20A, respectively, for example.

### Modification Example 2

Furthermore, although the turn-machining multi-edge tool 40 or the ball end mill 45 has been exemplified as a tool used in the first embodiment, the second embodiment, and the third embodiment, respectively, the present invention is not limited to the cases, for example. It is also possible to apply the present invention to a desired tool, for example.

Note that it is possible to achieve the functions included in the numerical control devices 10, 10A, and 10B according to the first embodiment, the second embodiment, and the third embodiment, respectively, through hardware, software, or a combination thereof. Note herein that achievement through software means achievement when a computer reads and executes programs.

It is possible to use a non-transitory computer readable medium that varies in type to store the programs, and to supply the programs to the computer. Examples of the non-transitory computer readable medium include tangible storage media that vary in type. Examples of the non-transitory computer readable medium include magnetic recording media (e.g., flexible disks, electromagnetic tape, and hard disk drives), magneto-optical recording media (e.g., magneto-optical discs), compact disc read only memories (CD-ROMs), compact disc-recordables (CD-Rs), compact disc-rewritables (CD-R/Ws), and semiconductor memories (e.g., mask ROMs, programmable ROMs (PROMs), erasable PROMs (EPROMs), flash ROMs, and random access memories (RAMs)). Furthermore, the programs may be supplied to the computer via a transitory computer readable medium that varies in type. Examples of the transitory computer readable medium include electric signals, optical signals, and electromagnetic waves. A transitory computer readable medium is able to supply the programs to the computer via wired communication channels such as electric wires and optical fibers or wireless communication channels.

Note that steps for describing programs to be recorded in a recording medium include not only processes sequentially executed in a chronological order, but also processes that may not necessarily be executed in a chronological order, but may be executed in parallel or separately.

In other words, it is possible that the numerical control device according to the present disclosure takes various types of embodiments having configurations described below.

(1) The numerical control device 10 according to the present disclosure is a numerical control device for the machining tool 20 that performs machining while changing a relative position and a relative posture of the tool 40 and the workpiece 50 based on the machining program 30, which includes: the relative posture setting unit 120 configured to set the relative posture of the tool 40 and the workpiece 50 partway through a block or partway through a cycle in the machining program 30; the dividing unit 130 configured to provide one or more division points in each block or each cycle and divide the block or the cycle into two or more sections; and the axis control unit 140 configured to cause the tool 40 or the workpiece 50 to move relative to each other to take the relative posture that the relative posture setting unit 120 has set in at least one section among the two or more sections.

With the numerical control device 10, it is possible to perform continuous machining while keeping a relative posture of a tool and a workpiece throughout a program route and prevent unevenness from occurring on a machining surface of the workpiece.

(2) In the numerical control device 10 described in (1), the relative posture that the relative posture setting unit 120 sets may be set based on a command value in the machining program 30 or a value stored beforehand in the numerical control device 10.

(3) In the numerical control device 10 described in (1) or (2), the tool shape storage unit 210 configured to store a geometrical shape of the tool 40 is further included, and the division points D1 and D2 may be acquired each at a position where a predetermined point on the tool 40 coincides with each of the division points, and, when the relative posture that the relative posture setting unit 120 has set is taken, no interference occurs between the tool 40 and the workpiece 50 when the geometrical shape is used.

By doing so, the numerical control device 10 makes it possible to cause the tool to move relatively while preventing an interference with the workpiece from occurring.

(4) In the numerical control device 10A described in any one of (1) to (3), the acceptable change amount storage unit 220a configured to store an acceptable change amount per unit period of time for the relative posture is further included, and the dividing unit 130a may determine division points D4 and D5 without allowing a change amount of the relative posture per unit period of time when the tool 45 and the workpiece 50 move relative to each other on a section between a start point or an end point of the block or the cycle and a division point D3 or D6 and a section coupling the division points D4 and D5 adjacent to each other to exceed the acceptable change amount.

By doing so, the numerical control device 10A makes it possible to determine an appropriate division point.

(5) In the numerical control device 10A described in (4), the dividing unit 130a may not divide the block or the cycle when it is determined that a change amount of the relative posture per unit period of time on the section between the start point or the end point of the block or the cycle and the division point D3 or D6 or the section coupling the division points D4 and D5 adjacent to each other exceeds the acceptable change amount.

By doing so, the numerical control device 10A makes it possible to avoid an unnecessary division of a block or a cycle.

(6) In the numerical control devices 10, 10A, and 10B each described in any one of (1) to (5), the dividing units 130 and 130a may not divide the block or the cycle when an amount of movement in the block or the cycle in a certain direction is smaller than a predetermined value.

By doing so, the numerical control devices 10, 10A, and 10B are able to prevent negative effects to a machining surface, which may occur if a relative posture intermittently changes in a block or a cycle according to which an amount of movement is small.

(7) In the numerical control device 10 described in any one of (1) to (4), the acceptable change amount storage unit 220 configured to store an acceptable change amount per unit period of time for a relative posture is further included, and the dividing unit 130 may determine a speed of relative movement without allowing a change amount of the relative posture per unit period of time when the tool 40 and the workpiece 50 move relative to each other on a section between a start point or an end point of the block or the cycle and the division point D1 or D2 and a section coupling the division points D1 and D2 adjacent to each other to exceed the acceptable change amount.

By doing so, the numerical control device 10 makes it possible to cause the tool 40 to move relatively at an appropriate speed.

### EXPLANATION OF REFERENCE NUMERALS

10, 10A, 10B Numerical control device
100, 100a, 100b Control unit
110 NC command decoding unit
120, 120a Relative posture setting unit
130, 130a, 130b Dividing unit
140 Axis control unit
200, 200a, 200b Storage unit
210, 210a Tool shape storage unit
220, 220a Acceptable change amount storage unit
20, 20A Machining tool
30 Machining program

1. A numerical control device for a machining tool that performs machining while changing a relative position and a relative posture of a tool and a workpiece based on a program, the numerical control device comprising:
a relative posture setting unit configured to set the relative posture of the tool and the workpiece partway through a block or partway through a cycle in the program;
a dividing unit configured to provide one or more division points in the block or the cycle and divide the block or the cycle into two or more sections; and
a axis control unit configured to cause the tool or the workpiece to move relative to each other to take the relative posture that the relative posture setting unit has set in at least one section among the two or more sections.

2. The numerical control device according to claim 1, wherein a relative posture that the relative posture setting unit sets is set based on a command value in the program or a value stored beforehand in the numerical control device.

3. The numerical control device according to claim 1 or 2, further comprising a tool shape storage unit configured to store a geometrical shape of the tool,
wherein the one or more division points are acquired each at a position where a predetermined point on the tool coincides with each of the one or more division points, and, when the relative posture that the relative posture setting unit has set is taken, no interference occurs between the tool and the workpiece when the geometrical shape is used.

4. The numerical control device according to any one of claims 1 to 3,
further comprising an acceptable change amount storage unit configured to store an acceptable change amount per unit period of time for the relative posture,
wherein the dividing unit determines the one or more division points without allowing a change amount of the relative posture per unit period of time when the tool and the workpiece move relative to each other on a section between a start point or an end point of the block or the cycle and each of the one or more division points and a section coupling the division points adjacent to each other to exceed the acceptable change amount.

5. The numerical control device according to claim 4, wherein the dividing unit does not divide the block or the cycle when it is determined that a change amount of the relative posture per unit period of time on the section between the start point or the end point of the block or the cycle and each of the one or more division points or the section coupling the division points adjacent to each other exceeds the acceptable change amount.

6. The numerical control device according to any one of claims 1 to 5, wherein the dividing unit does not divide the block or the cycle when an amount of movement in the block or the cycle in a certain direction is smaller than a predetermined value.

7. The numerical control device according to any one of claims 1 to 4,
further comprising an acceptable change amount storage unit configured to store an acceptable change amount per unit period of time for the relative posture,
wherein the dividing unit determines a speed of the relative movement without allowing a change amount of the relative posture per unit period of time when the tool and the workpiece move relative to each other on a section between a start point or an end point of the block or the cycle and each of the one or more division points and a section coupling the division points adjacent to each other to exceed the acceptable change amount.
